(19) United States
(12) Patent Application Publication
(10) Pub. No.: US 2025/0070332 A1
(43) Pub. Date: Feb. 27, 2025

(54) BATTERY CELL, BATTERY, AND ELECTRICAL DEVICE

(71) Applicant: CONTEMPORARY AMPEREX TECHNOLOGY (HONG KONG) LIMITED, Hong Kong (CN)

(72) Inventors: Qi CHENG, Ningde (CN); Hong WANG, Ningde (CN); Wenwei CHEN, Ningde (CN); Jian ZHOU, Ningde (CN); Quankun LI, Ningde (CN)

(21) Appl. No.: 18/942,232

(22) Filed: Nov. 8, 2024

Related U.S. Application Data
(63) Continuation of application No. PCT/CN2022/107137, filed on Jul. 21, 2022.

(51) Int. Cl. H01M 50/14; H01M 50/586

(52) U.S. Cl. CPC H01M 50/14; H01M 50/586

(57) ABSTRACT

A battery cell includes a case having an end portion opening; an electrode assembly arranged in the case; a cover plate arranged on the end portion opening; an isolation structure arranged on one side of the cover plate adjacent to the electrode assembly; and a supporting member fixedly connected to the isolation structure and configured to support the electrode assembly.

### CROSS-REFERENCE TO RELATED APPLICATION

This application is a continuation of International Application No. PCT/CN2022/107137, filed on Jul. 21, 2022, the entire content of which is incorporated herein by reference.

### TECHNICAL FIELD

The present disclosure relates to the technical field of batteries, and more particularly to a battery cell, a battery, and an electrical device.

### BACKGROUND ART

Secondary batteries, especially lithium-ion batteries, have the advantages of high voltage, large specific energy, long cycle life, pollution-free, wide operating temperature range, and small self-discharge. They are widely used in portable electronic devices and power devices of large new-energy electric vehicles, and are of great significance to solving human environmental pollution and energy crisis. As lithium-ion batteries are widely used, users are increasingly concerned about their reliability.

### SUMMARY

In an aspect of the present disclosure, a battery cell is provided, including:
a case having an end portion opening;
an electrode assembly arranged in the case;
a cover plate arranged on the end portion opening;
an isolation structure arranged on one side of the cover plate adjacent to the electrode assembly; and
a supporting member fixedly connected to the isolation structure and configured to support the electrode assembly.

The supporting member is fixedly connected to the isolation structure to achieve stability of relative positions between the supporting member and the isolation structure, and achieves a supporting function of the electrode assembly in the case by using the stiffness of the supporting member itself to control the movement and deformation of the electrode assembly in the case, and inhibit the displacement of the electrode assembly, thereby effectively protecting the electrode assembly and improving the reliability of using the battery cell.

In some embodiments, the supporting member is a plate-shaped supporting member, and the supporting member includes:
a first section, wherein the first section is arranged opposite to a main body part of the electrode assembly in a thickness direction of the supporting member; and
a second section, wherein the second section is located on at least one side of the first section in a thickness direction of the cover plate, and the second section protrudes from the main body part of the electrode assembly in the thickness direction of the cover plate,
wherein the second section is fixedly connected to the isolation structure.

The first section of the supporting member is arranged opposite the main body part of the electrode assembly in the thickness direction of the supporting member, which can effectively isolate the main body part of the electrode assembly from the case, while the second section of the supporting member is located on at least one side of the first section in the thickness direction of the cover plate, and the second section protrudes from the main body part of the electrode assembly in the thickness direction of the cover plate, which is equivalent to that the length of the second section of the supporting member in the thickness direction of the cover plate does not overlap with the length of the main body part of the electrode assembly in the thickness direction of the cover plate, so that the second section is avoided from being interfered by the main body part of the electrode assembly when it is fixedly connected to the isolation structure. Therefore, the isolation structure can have a sufficient space to connect the second section, thereby improving the reliability of the connection between the isolation structure and the supporting member.

In some embodiments, a surface of one side of the first section adjacent to the main body part is fixedly connected to the main body part.

The supporting member is fixedly connected to the main body part through the first section, and is fixedly connected to the isolation structure through the second section, so that the supporting function of the electrode assembly in the case can be achieved by using the stiffness of the supporting member itself to control the movement and deformation of the electrode assembly in the case, and inhibit the displacement of the electrode assembly in the case, thereby reducing the risk of a tab being torn due to the displacement of the electrode assembly.

In some embodiments, a surface of one side of the first section adjacent to the main body part is in integral contact with the main body part.

The first section of the supporting member is in integral contact with and fixedly connected to the main body part. In this way, a wider range of supporting function is formed for the main body part in the thickness direction of the cover plate by the supporting member, and the deformation of the electrode assembly is more effectively controlled, so that the main body part is not easy to collide or rub against an inner wall of the case due to deformation, thereby more effectively protecting the electrode assembly and improving the reliability of the battery cell.

In some embodiments, the second section is fixedly connected to the isolation structure by hot melting.

The second section and the isolation structure are fixedly connected by hot melting, which is easy to implement in terms of technology. Moreover, when the second section beyond the main body part is hot-melt connected to the isolation structure, a relatively sufficient hot-melt space can be obtained to ensure the reliability of the hot-melt connection.

In some embodiments, the hot-melt connection structure between the second section and the isolation structure includes a positioning hole and a hot-melt pillar. The hot-melt pillar passes through the positioning hole and is hot-melt connected to the positioning hole.

By passing the hot-melt pillar through the positioning hole, the positioning function before hot-melt connection can be realized, thereby limiting the relative positions between the supporting member and the isolation structure, and ensuring a reliable hot-melt connection between the supporting member and the isolation structure while avoiding the displacement between the supporting member and the isolation structure during the hot-melt connection, which is beneficial to the accuracy of subsequent assembling.

In some embodiments, in the thickness direction of the plate-shaped supporting member, there is a gap T1 between the surface of one side of the second section adjacent to the isolation structure and the isolation structure.

When the second section is fixedly connected to the isolation structure, the fixed connection structure may cause deformation of the supporting member. For example, the stress at a hot-melt part during the hot-melt connection may cause deformation of the supporting member. For the case where the first section of the supporting member is fixedly connected to the main body part of the electrode assembly, deformation of the supporting member may affect the fixed connection between the supporting member and the electrode assembly. The use of the gap T1 between the surface of one side of the second section adjacent to the isolation structure and the isolation structure can help reduce the deformation of the supporting member. For the hot-melt connection between the isolation structure and the second section, the gap T1 can reduce the stress in the hot-melt part, thereby reducing the deformation of the supporting member.

In some embodiments, T1 meets:

0.2*T2≤T1≤T2;
wherein T2 is the thickness of the plate-shaped supporting member.

The thickness of the supporting member affects the stiffness of the supporting member itself. Setting the gap according to the thickness of the supporting member can control the reasonable deformation of the supporting member during fixed connection, such as hot-melt fixing. For the fixed connection between the supporting member and the electrode assembly, a reliable connection between the supporting member and the electrode assembly can be ensured.

If the gap T1 is too high or too low, when the second section is hot-melt fixed to the isolation structure, the hot-melt part may form a stress that pulls or squeezes the second section, so that the hot-melting effect becomes worse, resulting in a significant deformation of the first section that is fixedly connected to the outer contour of the electrode assembly, which may affect the reliable connection between the supporting member and the electrode assembly. Therefore, by making the height of the gap meet a specific size relationship with the thickness of the supporting member, the hot-melt effect can be improved to achieve a reliable connection between the supporting member and the electrode assembly.

In some embodiments, in the thickness direction of the cover plate, the minimum distance T3 from a connection part of the second section and the isolation structure to an end portion of one side of the isolation structure adjacent to the main body part meets:

4*T2≤T3≤15*T2;
wherein T2 is the thickness of the plate-shaped supporting member.

The thickness of the supporting member affects the stiffness of the supporting member itself. Setting the position of the fixed connection part relative to the isolation structure according to the thickness of the supporting member can control the reasonable deformation of the supporting member during fixed connection, such as hot-melt connection, thereby ensuring a reliable connection between the supporting member and the electrode assembly.

If the hot-melt part is too close to the end portion of the isolation structure, the hot-melt range may be limited and it may be difficult to achieve a reliable connection, which may affect the hot-melt effect. For the hot-melt part, if the hot-melt part is too far away from the end portion of the isolation structure, an isolation structure with a thicker size is required, which affects the length of the electrode assembly, thereby affecting the capacity of the battery cell. Therefore, by making the distance of the connection part relative to the end portion of the isolation structure meet the specific size relationship with the thickness of the supporting member, the connection effect, such as the hot-melt effect, can be improved, thereby realizing a reliable connection between the supporting member and the electrode assembly, and improving the capacity of the battery cell.

In some embodiments, the main body part of the electrode assembly and the supporting member are fixed by bonding with an adhesive tape.

The supporting member and the main body part of the electrode assembly are fixed by bonding with the adhesive tape, so that the connection operation of the supporting member and the main body part is more convenient, and there is no need to provide other structures for connection on the supporting member and the electrode assembly.

In some embodiments, the main body part of the electrode assembly and the supporting member are fixed by bonding with a plurality of adhesive tapes, and the plurality of adhesive tapes are arranged at intervals in the thickness direction of the cover plate.

Compared with the method of fixing the electrode assembly and the supporting member by bonding with a long whole section of adhesive tape, a plurality of adhesive tapes arranged at intervals can meet the requirement of fixed connection while saving the amount of adhesive tape and saving costs.

In some embodiments, in the thickness direction of the cover plate, the width T4 of each adhesive tape meets:

0.02*L≤T4≤0.2*L;
wherein L is the length of the supporting member in the thickness direction of the cover plate.

When the plurality of adhesive tapes arranged at intervals in the length direction of the electrode assembly are used to achieve the fixed connection between the electrode assembly and the supporting member, an excessively wide adhesive tape requires a larger amount of adhesive tape and increases the cost, while an excessively narrow adhesive tape cannot achieve sufficient connection strength and thus affecting the reliability of the fixed connection. Therefore, by making the width of the adhesive tape meet the specific size relationship with the length of the supporting member, the amount of adhesive tape can be saved as much as possible and the costs can be reduced while ensuring the reliable fixed connection between the supporting member and the electrode assembly.

In some embodiments, the supporting member has two end portions in the thickness direction of the cover plate, and spacings T5 between two adhesive tapes respectively adjacent to the two end portions among the plurality of adhesive tapes and the corresponding end portions meet:

0.04*L≤T5≤0.2*L;
wherein L is the length of the supporting member in the thickness direction of the cover plate.

The spacing T5 reflects the position of an outermost adhesive tape among the plurality of adhesive tapes on the supporting member. When the outermost adhesive tape adheres and fixes the supporting member, lifting of the end portion of the supporting member can be effectively controlled. If the spacing T5 is too large, the control effect of lifting of the end portion of the supporting member will be affected. If the spacing T5 is too small, the hot-melt region between the supporting member and the isolation structure may be restricted. Therefore, by making the spacing T5 meet the specific size relationship with the length L of the supporting member, the influence on the hot-melt region can be reduced and the lifting of the end portion of the supporting member can be alleviated.

In some embodiments, in the thickness direction of the cover plate, a spacing T6 between adjacent adhesive tapes in the plurality of adhesive tapes meets:

0.1*L≤T6≤0.5*L;
wherein L is the length of the supporting member in the thickness direction of the cover plate.

The plurality of adhesive tapes are arranged at intervals being the spacings T6, so that the fixed connection function of the adhesive tapes can be distributed evenly in the length direction of the electrode assembly, which effectively controls the deformation of different positions of the supporting member, thereby achieving a more reliable fixed connection relationship between the electrode assembly and the supporting member. An excessively large spacing T6 affects the connection strength between the electrode assembly and the supporting member, while an excessively small spacing T6 may increase the amount of adhesive tape, increase costs, and also increase the process of pasting the adhesive tape. Therefore, by making the spacing of the adjacent adhesive tapes meet the specific size relationship with the length of the supporting member, the amount of adhesive tape can be saved as much as possible, the costs can be reduced, and the process can be saved while ensuring the reliable fixed connection between the supporting member and the electrode assembly.

In some embodiments, the battery cell includes two cover plates, two end portion openings are respectively provided at both ends of the case, and each of the cover plates is arranged on the corresponding end portion opening.

The two cover plates are respectively arranged on the end portion openings at both ends of the case, for closing the end portion openings, so that the two cover plates and the case jointly form a sealed cavity for accommodating the electrode assembly, thereby effectively protecting the electrode assembly and ensuring that the electrode assembly is capable of working stably for a long time.

In some embodiments, the two cover plates include a first cover plate connected to an end portion opening on one side of the case; the isolation structure includes: a first insulating block and a second insulating block, the first insulating block is fixed on a surface of one side of the first cover plate adjacent to the electrode assembly, and at least a part of the second insulating block is located between the first insulating block and the main body part of the electrode assembly, and is fixedly connected to the supporting member.

The isolation structure separates the first cover plate and the main body part of the electrode assembly through the second insulating block to prevent damage to the electrode assembly caused by collision between the main body part and the first cover plate, and the second insulating block is fixedly connected to the supporting member, which can achieve the stability of the relative positions between the supporting member and the isolation structure. By arranging at least a part of the second insulating block between the first insulating block fixed on the surface of the first cover plate and the main body part, the second insulating block can play a position-limiting role on the main body part, thereby avoiding the risk of the main body part displacing due to vibration and other reasons when the battery cell is in use, thereby causing damage to the electrode assembly or even a short circuit.

In some embodiments, the first insulating block is configured to limit the position of the second insulating block in at least one of the first direction and the second direction, and is in clearance fit with the second insulating block at least one of the first direction and the second direction, and the first direction and the second direction are perpendicular to each other and both are perpendicular to the thickness direction of the cover plate.

The isolation structure, by using the first insulating block to limit the position of the second insulating block in at least one of the first direction and the second direction, in cooperation with the fixed connection between the second insulating block and the supporting member and the position-limiting effect on the main body part, effectively limits the relative positions between the electrode assembly and an end cover assembly, thereby reducing the risk of the electrode assembly displacing due to vibration and other reasons when the battery cell is in use, thereby causing damage to the electrode assembly or even a short circuit.

The position-limiting effect of the first insulating block on the second insulating block in at least one of the first direction and the second direction is achieved through clearance fit, which can effectively reduce the possibility of interference between the first insulating block and the second insulating block during assembling, reduce the difficulty in assembling, and avoid the problem of difficult or unsuccessful assembling caused by manufacturing errors of components or errors in the operation of assembling tools.

In some embodiments, the two cover plates further include a second cover plate connected to the end portion opening on the other side of the case. The isolation structure is fixed on a surface of one side of the second cover plate adjacent to the electrode assembly, and is fixedly connected to the supporting member.

The isolation structure arranged on the surface of one side of the second cover plate adjacent to the electrode assembly is capable of separating the second cover plate from the main body part of the electrode assembly, for preventing damage to the electrode assembly caused by collision between the main body part and the second cover plate. Moreover, the isolation structure is further fixedly connected to the supporting member, which can achieve the stability of relative positions between the supporting member and the isolation structure.

In some embodiments, the supporting member has a plurality of hollowed-out or thinned accommodation regions, and the total volume V1 of the plurality of hollowed-out or thinned accommodation regions and the total volume V2 of the solid part of the supporting member meet:

$$5 \% \leq V 1 : ( V 1 + V 2 ) \leq 30 \% .$$

Since the supporting member will occupy a certain space in the case, in order to reduce the impact of the volume of the supporting member on the space inside the case, a plurality of hollowed-out or thinned accommodation regions are arranged on the supporting member to provide more accommodation space for the electrolyte solution, thereby increasing the amount of electrolyte solution in the battery cell, and improving the cycle life of the battery cell. In addition, the stamping process of the hollowed-out accommodation region is easy to implement, thereby reducing the difficulty of processing, and being conducive to the entry, exit, and flow of the electrolyte solution.

In some embodiments, the plurality of hollowed-out or thinned accommodation regions include: a plurality of circular holes, and the diameter D of each circular hole meets:

$$( 1 / 3 ) * W \leq D \underline{<} ( 2 / 3 ) * W ;$$

wherein W is the width of the supporting member in the thickness direction of the main body part of the electrode assembly. The circular hole is capable of implementing the accommodation function for the electrolyte solution and gas, and is easy to process and form.

If the diameter of the circular hole is too large, the strength and rigidity of the supporting member will be weakened, thereby affecting the supporting effect of the supporting member on the electrode assembly. If the diameter of the circular hole is too small, the space to accommodate the electrolyte solution will be limited. Therefore, by making the diameter of the circular hole meet a specific size relationship with the width of the supporting member, the amount of the electrolyte solution in the battery cell can be increased and the cycle life of the battery cell can be improved while meeting the reliable supporting effect of the supporting member on the electrode assembly.

In some embodiments, the plurality of hollowed-out or thinned accommodation regions are arranged at equal intervals in the thickness direction of the cover plate.

By arranging the accommodation regions at equal intervals, the impact of the hollowed-out or thinned accommodation regions on the stiffness and strength of the supporting member may be more uniform, thereby avoiding local insufficient strength or local large deformation of the supporting member, and improving the supporting effect of the supporting member on the electrode assembly.

In some embodiments, the battery cell further include:
an insulating member located within the case and wrapping at least a part of the electrode assembly and at least a part of the supporting member, and configured to separate the case from the electrode assembly;
wherein a region of the insulating member wrapping the supporting member has a first positioning hole, the supporting member has a second positioning hole, and the first positioning hole does not overlap with the second positioning hole.

The insulating member can separate a cavity of the case and the electrode assembly to achieve insulation between the electrode assembly and the case. By making the first positioning hole not overlapping with the second positioning hole, the electrode assembly may be effectively prevented from lap-jointing with the case through the second positioning hole and the first positioning hole to cause corrosion of the case.

In some embodiments, the supporting member has a plurality of hollowed-out or thinned accommodation regions, and the second positioning hole is located on one side of the plurality of hollowed-out or thinned accommodation regions adjacent to the end portion of the supporting member.

Arranging the second positioning hole on the supporting member in a position adjacent to the end portion can facilitate the positioning and operation of the supporting member by a positioning device.

In some embodiments, the supporting member has a plurality of hollowed-out or thinned accommodation regions, and a hollowed-out accommodation region among the plurality of hollowed-out or thinned accommodation regions does not overlap with the first positioning hole.

By making the first positioning hole on the supporting member not overlapping with the hollowed-out accommodation region, the electrode assembly may be effectively prevented from lap-jointing with the case through the hollowed-out accommodation region and the first positioning hole to cause corrosion of the case.

In one aspect of the present disclosure, a battery is provided, including the aforementioned battery cell. The battery using the aforementioned battery cell can achieve better reliability in use.

In one aspect of the present disclosure, an electrical device is provided, including the aforementioned battery. The electrical device using the aforementioned battery can achieve better reliability in use.

### DESCRIPTION OF DRAWINGS

In order to illustrate the technical solutions of the embodiments of the present disclosure more clearly, the following briefly introduces the drawings required in the embodiments of the present disclosure. Obviously, the drawings described below are only some embodiments of the present disclosure. For those of ordinary skill in the art, other drawings can also be obtained according to the drawings without any creative efforts.

The present disclosure may be more clearly understood from the following detailed description with reference to the accompanying drawings, in which:

FIG. 1 is a schematic structural diagram of some embodiments of an electrical device according to the present disclosure;

FIG. 2 is a schematic exploded diagram of some embodiments of a battery according to the present disclosure;

FIG. 3 is a schematic exploded diagram of some embodiments of a battery cell according to the present disclosure;

FIG. 4 is an enlarged schematic diagram of a region corresponding to an ellipse A1 in FIG. 3;

FIG. 5 is an enlarged schematic diagram of a region corresponding to an ellipse A2 in FIG. 3;

FIG. 6 is a schematic structural diagram of an electrode assembly in some embodiments of the battery cell according to the present disclosure;

FIG. 7 is a schematic structural diagram of FIG. 6 from another perspective;

FIG. 8 is a schematic diagram of a section AA in FIG. 7;

FIG. 9 is an enlarged schematic diagram of a region corresponding to a circle B in FIG. 8; and

FIG. 10 is a schematic partial structural diagram of an insulating member wrapping an electrode assembly in some embodiments of the battery cell according to the present disclosure.

It should be understood that the dimensions of the various parts shown in the drawings are not drawn to actual proportion relationships. In addition, the same or similar reference numerals indicate the same or similar components.

### LIST OF REFERENCE NUMERALS

10: Battery cell;
20: Case; 21: Cavity; 22: End portion opening;
30: Electrode assembly; 31: Main body part; 32: Tab;
40: End cover assembly; 41: Cover plate; 411: First cover plate; 412: Second cover plate; 42: Isolation structure; 421: First insulating block; 422: Second insulating block; 423: Third insulating block; 441: First terminal post; 442: Second terminal post; 43: Hot-melt pillar;
50: Supporting member; 51: First section; 52: Second section; 53: Positioning hole; 54: Adhesive tape; 55: Second positioning hole; 56: Accommodation region;
60: Insulating member; 61: First positioning hole;
70: Battery; 71: Box body;
80: Vehicle; 81: Controller; 82: Motor.

### DETAILED DESCRIPTION

The implementations of the present disclosure are further described in detail below with reference to the drawings and embodiments. The following detailed description of the embodiments and the drawings are used to illustrate the principles of the present disclosure by way of example, but should not be used to limit the scope of the present disclosure, that is, the present disclosure is not limited to the described embodiments.

In the description of the present disclosure, it should be noted that, unless otherwise stated, “a plurality of” means two or more; the orientation or positional relationships indicated by the terms “upper,” “lower,” “left,” “right,” “inner,” “outer,” and the like are only for facilitating the description of the present disclosure and simplifying the description, rather than indicating or implying that the apparatus or element referred to must have a particular orientation or be constructed and operated in a particular orientation, and therefore should not be interpreted as limiting the present disclosure. In addition, the terms “first,” “second,” “third,” and the like are used for descriptive purposes only, and cannot be construed as indicating or implying relative importance. “Vertical” is not strictly vertical, but within an allowed error range. “Parallel” is not strictly parallel, but within an allowed error range.

The orientation words appearing in the following description are directions shown in the figures and do not limit the specific structure of the present disclosure. In the description of the present disclosure, it should be further illustrated that, unless otherwise expressly specified and defined, terms “mounted,” “connected,” and “connection” should be understood broadly, and may be, for example, a fixed connection or detachable connection, or integral connection; and may also be direct connection or indirect connection through an intermediate medium. For those of ordinary skill in the art, the specific meanings of the above terms in the present disclosure may be understood according to specific circumstances.

In this disclosure, the phrases “at least one of A, B, and C” and “at least one of A, B, or C” both mean only A, only B, only C, or any combination of A, B, and C.

Some implementations of the present disclosure are described in detail in the following through the accompanying drawings. Without conflict, features in the following embodiments may be combined together.

In a battery cell of some related arts, an electrode assembly may displace within a case due to changes in a movement state of a battery or due to an external force during the use of the battery cell. The displacement of the electrode assembly may cause pulling of connections between tabs and terminal posts at both ends of a main body part, and cause the risk of loosening of the electrical connection or tearing of the tabs, thereby reducing the reliability of the battery cell.

In view of this, an embodiment of the present disclosure provides a battery cell, a battery, and an electrical device, which can improve the reliability of the battery.

The battery cell in the embodiment of the present disclosure may include a lithium-ion secondary battery, a lithium-ion primary battery, a lithium-sulfur battery, a sodium/lithium-ion battery, a sodium-ion battery, a magnesium-ion battery, or the like, which will not be limited in the embodiments of the present disclosure. The battery cell may be cylindrical, flat, rectangular, or in other shapes, which is not limited in the embodiments of the present disclosure.

The battery cell in the embodiments of the present disclosure is applicable to various types of batteries. The battery may be used for supplying power to an electrical device such as a vehicle, for example, providing a power source for manipulating the vehicle or providing a power source for driving the vehicle. The battery may include a case and a battery module. The case is used for providing an accommodating space for the battery module. The battery module is mounted in the case. The case may adopt a metal material. The battery module may include a plurality of battery cells in series connection, parallel connection, or parallel-series connection. A battery cell is the smallest unit forming the battery. The battery cell includes an electrode assembly that is capable of generating an electrochemical reaction.

The battery in the embodiment of the present disclosure is applicable to various types of electrical devices using batteries. The electrical device may be a mobile phone, a portable apparatus, a laptop, a battery vehicle, an electric vehicle, a ship, a spacecraft, an electronic toy, an electric tool, and the like. For example, the spacecraft includes an airplane, a rocket, a space shuttle, a spaceship, and the like; the electronic toy includes a fixed or mobile electronic toy, such as a game console, an electric vehicle toy, an electric ship toy, an electric aircraft toy, and the like; and the electric tool includes a metal-cutting power tool, a grinding power tool, an assembly power tool, and a railway power tool, such as an electric drill, an electric grinder, an electric wrench, an electric screwdriver, an electric hammer, an electric impact drill, a concrete vibrator, and an electric planer. The electrical device is not specially limited in the embodiments of the present disclosure.

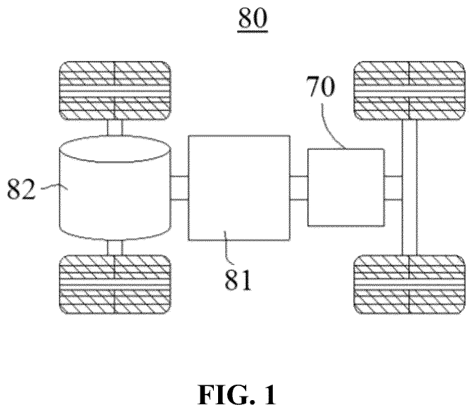

FIG. 1 is a schematic structural diagram of some embodiments of an electrical device according to the present disclosure. For the convenience of description, the electrical apparatus being a vehicle is illustrated as an example. A vehicle 80 may be a fuel vehicle, a gas vehicle, or a new-energy vehicle, and the new-energy vehicle may be an all-electric vehicle or a hybrid vehicle. For example, a battery 70 may be arranged at the bottom or the head or the tail of the vehicle 80.

The battery 70 may be used for the power supply of the vehicle 80, for example, the battery 70 may be used as an operating power source for the vehicle 80, and used in a circuit system of the vehicle 80, such as for the working power demand during the start-up, navigation, and operation of the vehicle 80. In some embodiments, the battery 70 may not only be used as the operating power source of the vehicle 80, but also may be used as a driving power source of the vehicle 80 to provide driving power for the vehicle 80 in place of or partially in place of fuel or natural gas.

The vehicle 80 may also be equipped with an axle, wheels, a motor 82, and a controller 81 inside. The controller 81 is used for controlling the battery 70 to power the motor 82. For example, when the vehicle 80 uses the battery 70 as a driving power source, the controller 81 may provide the motor 82 with the power required for constant speed and acceleration. The motor 82 is used for driving the axle to rotate to drive the wheels to rotate.

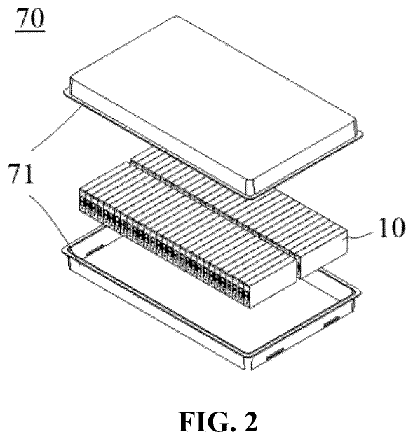

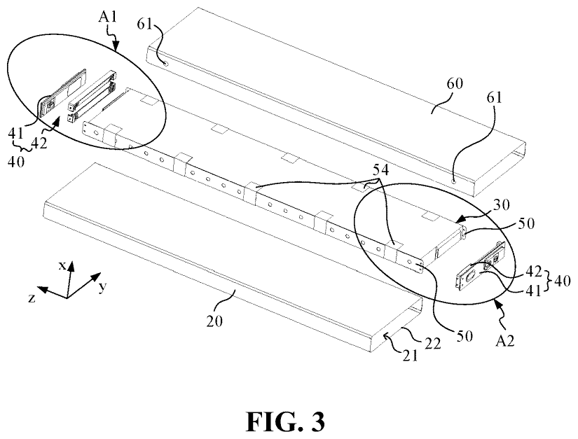

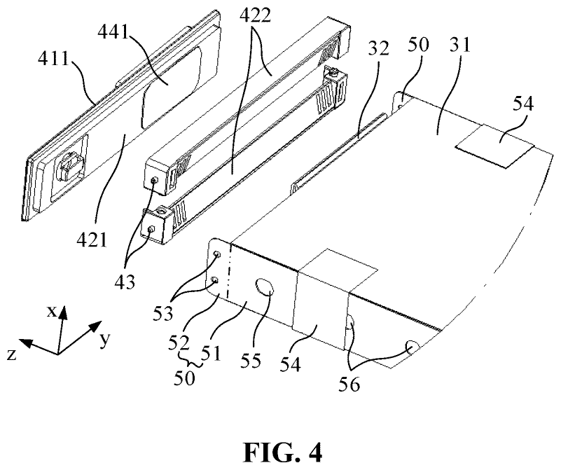

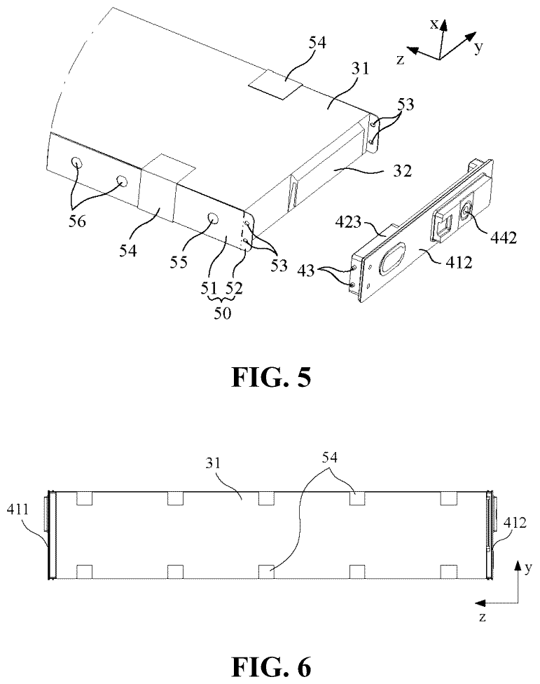

FIG. 2 is a schematic structural diagram of some embodiments of a battery according to the present disclosure. FIG. 3 is a schematic exploded diagram of some embodiments of a battery cell according to the present disclosure. FIG. 4 is an enlarged schematic diagram of a region corresponding to an ellipse A1 in FIG. 3. FIG. 5 is an enlarged schematic diagram of a region corresponding to an ellipse A2 in FIG. 3.

Referring to FIG. 2, in some embodiments, the battery 70 includes a box body 71 and one or more battery cells 10 arranged in the box body 71. The box body 71 can provide the battery cell 10 with functions such as cooling, sealing, and anti-impact, and is further capable of preventing adverse impacts of liquid or other foreign matters on the charging, discharging, or safety of the battery cell.

Referring to FIG. 2, the various battery cells 10 are electrically connected, such as in series, parallel, or parallel-series connection, to achieve required electrical performance parameters of the battery 70. A plurality of battery cells 10 are arranged in rows, and one or more rows of battery cells 10 may be arranged in the box body as needed.

In some embodiments, the various battery cells 10 of the battery 70 may be arranged in at least one of the length direction and the width direction of the box body. At least one row or column of battery cells 70 may be arranged according to actual requirements. According to requirements, one or more layers of battery cells 10 may also be arranged in the height direction of the battery 70.

In some embodiments, the plurality of battery cells 10 may be in series, parallel, or parallel-series connection to form battery modules first, and then the plurality of battery modules may be in series, parallel, or parallel-series connection to form into an entirety accommodated in the box body 71. In some other embodiments, all the battery cells 10 are directly in series, parallel, or parallel-series connection, and then an entirety composed of all the battery cells 10 may be accommodated in the box body.

Referring to FIG. 3, in the embodiment of the present disclosure, a battery cell 10 includes: a case 20, an electrode assembly 30, a cover plate 41, an isolation structure 42, and a supporting member 50. The case 20 has an end portion opening 22. The electrode assembly 30 is arranged in the case 20. The cover plate 41 is arranged on the end portion opening 22. The isolation structure 42 is arranged on one side of the cover plate 41 adjacent to the electrode assembly 30. The supporting member 50 is fixedly connected to the isolation structure 42 and configured to support the electrode assembly 30.

The supporting member 50 is fixedly connected to the isolation structure 42 to achieve stability of relative positions between the supporting member 50 and the isolation structure 42, and achieves a supporting function of the electrode assembly 30 in the case 20 by using the stiffness of the supporting member 50 itself to control the movement and deformation of the electrode assembly 30 in the case 20, and inhibit the displacement of the electrode assembly 30, thereby effectively protecting the electrode assembly 30 and improving the reliability of the battery cell.

A cavity 21 of the case 20 may be used for accommodating the electrode assembly 30 and may accommodate an electrolyte solution. The end portion opening 22 is used for allowing the electrode assembly 30 to enter the cavity 21 through the end portion opening 22 when the battery cell is mounted. The shape of the case 20 may be determined according to the shape of one or more electrode assemblies 30 accommodated in the cavity. For example, the shape of the case 20 may be a hollow cuboid, a hollow cube, or a hollow cylinder. The case 20 may be made of metal (such as aluminum and aluminum alloy) or a non-metal material (plastic) with certain hardness and strength.

The cover plate 41 is arranged on the end portion opening 22 for closing the end portion opening 22, and forms a sealed cavity with the case 20 to accommodate the electrode assembly 30. The cover plate 41 may be made of metal (such as aluminum and aluminum alloy) or a non-metal material (plastic) with certain hardness and strength. The cover plate 41 and the case 20 may be fixedly connected by welding, bonding, or connecting through connectors. Some functional components may be provided on the cover plate 41, such as a terminal post for electrical connection with the electrode assembly, a liquid injection mechanism, and a pressure relief mechanism.

The case 20 may have one or two end portion openings 22, and accordingly, one or two cover plates 41 may be used for covering. In some embodiments, the battery cell 10 includes two cover plates 41, two end portion openings 22 are respectively provided at both ends of the case 20, and each of the cover plates 41 is arranged on the corresponding end portion opening 22. The two cover plates are respectively arranged on the end portion openings at both ends of the case, for closing the end portion openings, so that the two cover plates and the case jointly form a sealed cavity for accommodating the electrode assembly, thereby effectively protecting the electrode assembly and ensuring that the electrode assembly is capable of working stably for a long time. In some other embodiments, the battery cell 10 may include a cover plate 41, one end of the case 20 is closed, and the other end has the end portion opening 22, and the cover plate 41 is arranged on the end portion opening 22.

The isolation structure 42 is arranged between the cover plate 41 and at least a part of the electrode assembly 30 (for example, the main body part 31 of the electrode assembly 30). A tab 32 of the electrode assembly 30 may pass through the isolation structure 42 to be electrically connected to the terminal post arranged on the cover plate 41.

In FIG. 4, the cover plate 41 may include a first cover plate 411, and the first cover plate 411 is connected to the end portion opening 22 on one side of the case 20. The isolation structure 42 may include: a first insulating block 421 and a second insulating block 422. The first insulating block 421 is fixed on a surface of one side of the first cover plate 411 adjacent to the electrode assembly 30, and at least a part of the second insulating block 422 is located between the first insulating block 421 and the main body part 31 of the electrode assembly 30, and fixedly connected to the supporting member 50.

The isolation structure 42 separates the first cover plate 411 and the main body part 31 of the electrode assembly 30 through the second insulating block 422 to prevent damage to the electrode assembly 30 caused by collision between the main body part 31 and the first cover plate 411, and the second insulating block 422 is fixedly connected to the supporting member 50, which can achieve the stability of the relative positions between the supporting member 50 and the isolation structure 42. By arranging at least a part of the second insulating block 422 between the first insulating block 421 fixed on the surface of the first cover plate 411 and the main body part 31, the second insulating block 422 can play a position-limiting role on the main body part 31, thereby avoiding the risk of the main body part 31 displacing due to vibration and other reasons when the battery cell is in use to cause damage to the electrode assembly 30 or even a short circuit.

Referring to FIG. 4, in some embodiments, the first insulating block 421 is configured to limit the position of the second insulating block 422 in at least one of the first direction x and the second direction y, and is in clearance fit with the second insulating block 422 in at least one of the first direction x and the second direction y, and the first direction x and the second direction y are perpendicular to each other and both are perpendicular to the thickness direction z of the cover plate 41.

For the flat box-shaped electrode assembly 30, the first direction x may be the thickness direction of the electrode assembly 30. For the plate-shaped supporting member 50, the second direction y may be the thickness direction of the supporting member 50.

The isolation structure 42, by using the first insulating block 421 to limit the position of the second insulating block 422 in at least one of the first direction x and the second direction y, in cooperation with the fixed connection between the second insulating block 422 and the supporting member 50 and the position-limiting effect on the main body part 31, effectively limits the relative positions between the electrode assembly 30 and the first cover plate 411, thereby reducing the risk of the electrode assembly 30 displacing due to vibration and other reasons when the battery cell is in use to cause damage to the electrode assembly 30 or even a short circuit.

The position-limiting effect of the first insulating block 421 on the second insulating block 422 in at least one of the first direction x and the second direction y is achieved through clearance fit, which can effectively reduce the possibility of interference between the first insulating block 421 and the second insulating block 422 during assembling, reduce the difficulty in assembling, and avoid the problem of difficult or unsuccessful assembling caused by manufacturing errors of components or errors in the operation of assembling tools.

The first insulating block 421 and the second insulating block 422 may be made of an insulating material such as plastic. In order that the tab 32 of the electrode assembly 30 is capable of being electrically connected to a first terminal post 441 arranged on the first cover plate 411, the second insulating block 422 may be provided with a channel for the tab 32 to pass through. The second insulating block 422 may adopt a split structure. The combined second insulating block 422 may form a channel for guiding the tab 32 to pass through. The tab 32 may be bent in a space surrounded by the second insulating block 422 and the first cover plate 411, and then achieve a reliable electrical connection with an end surface of the terminal post 411.

In FIG. 5, the two cover plates 41 further include a second cover plate 412. A second terminal post 442 with an opposite polarity to the first terminal post 441 may be arranged on the second cover plate 412. The second terminal post 442 is electrically connected to the tab 32 on the other side of the main body part 31 of the electrode assembly 30. The second cover plate 412 is connected to the end portion opening 22 on the other side of the case 20. The isolation structure 42 (that is, a third insulating block 423) is fixed on a surface of one side of the second cover plate 412 adjacent to the electrode assembly 30 and is fixedly connected to the supporting member 50. The third insulating block 423 may also be made of an insulating material such as plastic.

The isolation structure arranged on the surface of one side of the second cover plate 412 adjacent to the electrode assembly 30 is capable of separating the second cover plate 412 from the main body part 31 of the electrode assembly 30, for preventing damage to the electrode assembly 30 caused by collision between the main body part 31 and the second cover plate 412. Moreover, the isolation structure 42 is further fixedly connected to the supporting member 50, which can achieve the stability of relative positions between the supporting member 50 and the isolation structure 42.

The electrode assembly 30 may include a positive electrode plate, a negative electrode plate, and a separator arranged between the positive electrode plate and the negative electrode plate. The battery cell operates mainly relying on movement of metal ions between the positive electrode plate and the negative electrode plate.

The positive electrode plate may include a positive electrode current collector and a positive electrode active material layer. A positive tab is connected to or formed on the positive electrode current collector. Taking a lithium-ion battery as an example, the material of the positive electrode current collector may be aluminum, and the positive electrode active material may be lithium cobalt oxide, lithium iron phosphate, ternary lithium, lithium manganate, or other lithium compounds that can provide lithium ions. When a binding material is used to bond the positive electrode current collector and the positive electrode active material layer, the binding material may be Polyvinylidene Fluoride (PVDF), and the like.

The negative electrode plate includes a negative electrode current collector and a negative electrode active material layer. The negative tab is connected to the negative electrode current collector. Taking a lithium-ion battery as an example, the material of the negative electrode current collector may be copper, and the negative electrode active material may be graphite, silicon, lithium titanate, and other substances that can store lithium ions. When a binding material is used to bond the negative electrode current collector and the negative electrode active material layer, the binding material may be Carboxyl methyl Cellulose, epoxy resin, styrene-butadiene rubber, and the like.

The material of the separator may be polypropylene (PP), polyethylene (PE), or the like. The electrolyte solution includes an electrolyte and a solvent. The electrolyte is an organic metal salt, an inorganic salt, or the like, which can provide metal ions that shuttle between the positive electrode plate and the negative electrode plate. To ensure sufficient overcurrent capacity, there may be a plurality of positive tabs stacked together, and there may be a plurality of negative tabs stacked together. In addition, the electrode assembly may be of a wound structure or a laminated structure, which is not limited in the embodiments of the present disclosure.

Referring to FIG. 3 to FIG. 5, the thickness direction z of the cover plate 41 may be parallel to the length direction of the flat box-shaped electrode assembly 30. The thickness direction (that is, the first direction x) of the flat box-shaped electrode assembly 30 is perpendicular to the thickness direction z of the cover plate 41. For the plate-shaped supporting member 50, the thickness direction (that is, the second direction y) of the supporting member 50 is perpendicular to the thickness direction z of the cover plate 41 and is also perpendicular to the thickness direction of the electrode assembly 30.

In some embodiments, the supporting member 50 may be fixedly connected to the outer contour of the electrode assembly 30 to provide a supporting function for the electrode assembly 30 while separating the electrode assembly 30 from an inner wall of the case 20. In some other embodiments, the supporting member 50 may not be connected to the outer contour of the electrode assembly 30 while implementing the function of separating the electrode assembly 30 from the inner wall of the case 20.

Referring to FIG. 4 and FIG. 5, in some embodiments, the supporting member 50 is a plate-shaped supporting member, and the supporting member 50 includes a first section 51 and a second section 52 (divided by double-dot dash lines in FIG. 4 and FIG. 5). The first section 51 is arranged opposite to the main body part 31 of the electrode assembly 30 in the thickness direction of the supporting member 50, and the second section 52 is located on at least one side of the first section 51 in the thickness direction z of the cover plate 41, and the second section 52 protrudes from the main body part 31 of the electrode assembly 30 in the thickness direction z of the cover plate 41. The second section 52 is fixedly connected to the isolation structure 42.

The first section 51 of the supporting member 50 is arranged opposite to the main body part 31 of the electrode assembly 30 in the thickness direction of the supporting member 50, which is equivalent to that the length of the first section 51 in the thickness direction z of the cover plate 41 overlaps with the length of the main body part 31 of the electrode assembly 30 in the thickness direction z of the cover plate 41, and can effectively isolate the main body part 31 of the electrode assembly 30 from the case 20. The second section 52 is located on at least one side of the first section 51 in the thickness direction z of the cover plate 41, and the second section 52 protrudes from the main body part 31 in the thickness direction z of the cover plate 41, which is equivalent to that the length of the second section 52 in the thickness direction z of the cover plate 41 does not overlap with the length of the main body part 31 of the electrode assembly 30 in the thickness direction z of the cover plate 41. In this way, the second section 52, when fixedly connected to the isolation structure 42, avoids interference from the main body part 31, so that the isolation structure 42 is capable of having a sufficient space to connect the second section 52, thereby improving the reliability of the connection between the isolation structure 42 and the supporting member 50.

In some embodiments, a surface of one side of the first section 51 of the supporting member 50 adjacent to the main body part 31 is fixedly connected to the main body part 31. The supporting member 50 is fixedly connected to the main body part 31 through the first section 51, and is fixedly connected to the isolation structure 42 through the second section 52, so that the supporting function of the electrode assembly 30 in the case 20 can be achieved by using the stiffness of the supporting member 50 itself to control the movement and deformation of the electrode assembly 30 in the case 20, and inhibit the displacement of the electrode assembly 30 in the case, thereby reducing the risk of a tab 32 being torn due to the displacement of the main body part 31.

Further, the surface of one side of the first section 51 adjacent to the main body part 31 may be in integral contact with the main body part 31. For example, the first section 51 is integrally fixed to the side of the main body part 31 by means of an adhesive tape 34. The overall contact here may be that a surface of the first section 51 is completely attached to an outer surface of the main body part 31, or it may be that a peripheral region of the first section 51 is attached to the outer surface of the main body part 31.

The first section 51 of the supporting member 50 is in integral contact with and fixedly connected to the main body part 31. In this way, the supporting member 50 forms a wider range of supporting function for the main body part 31 in the thickness direction z of the cover plate 41, and controls the deformation of the electrode assembly 30 in the case 20 more effectively, so that it is difficult for the main body part to collide or rub against the inner wall of the case due to deformation, thereby reducing the risk of corrosion of the case or even short circuit caused by the electrode assembly 30 contacting the inner wall of the case 20, effectively protecting the electrode assembly 30, and improving the reliability of the battery cell.

The supporting member 50 may extend in the length direction of the electrode assembly 30 and be located on at least one side of the electrode assembly 30. In FIG. 3, for the flat-shaped electrode assembly 30, the supporting member 50 may be a plate-shaped supporting member and is respectively arranged on narrow edges at both sides of the electrode assembly 30 to serve as a side supporting plate. The supporting member 50 may be made of a material with certain strength and rigidity, such as plastic.

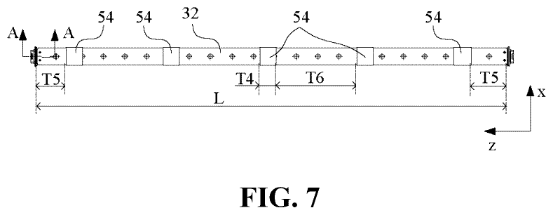

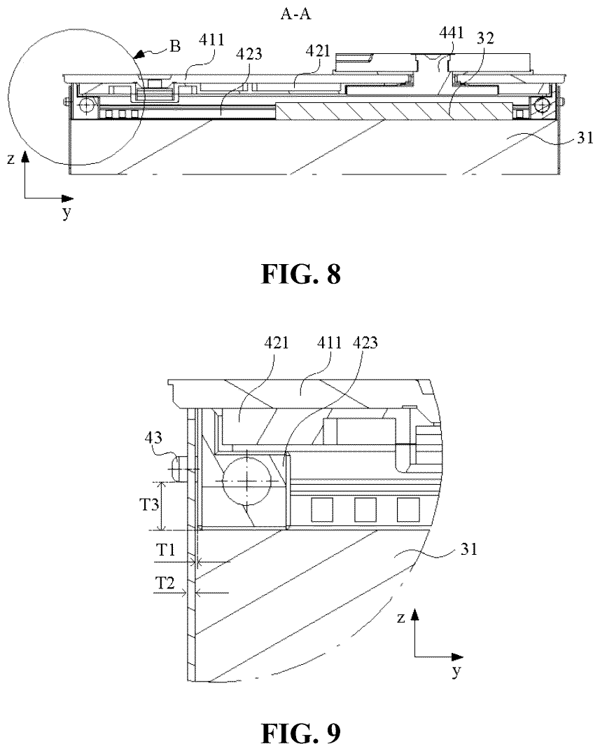

FIG. 6 is a schematic structural diagram of an electrode assembly in some embodiments of the battery cell according to the present disclosure. FIG. 7 is a schematic structural diagram of FIG. 6 from another perspective. FIG. 8 is a schematic diagram of a section AA in FIG. 7. FIG. 9 is an enlarged schematic diagram of a region corresponding to a circle B in FIG. 8.

Referring to FIG. 8 and FIG. 9, the second section 52 and the isolation structure 42 may be fixedly connected in various manners, for example, fixedly connected by hot melting. The fixed connection by hot melting is easy to implement in terms of technology. Moreover, when the second section beyond the main body part is hot-melt connected to the isolation structure, a relatively sufficient hot-melt space can be obtained to ensure the reliability of the hot-melt connection.

Referring to FIG. 4, FIG. 5, and FIG. 9, in some embodiments, the hot-melt connection structure between the second section 52 and the isolation structure 42 includes a positioning hole 53 and a hot-melt pillar 43. The hot-melt pillar 43 passes through the positioning hole 33 and is hot-melt connected to the positioning hole 33. The positioning hole 33 may be opened in the second section 52, and accordingly the hot-melt pillar 43 is located on the surface of the isolation structure 42.

By passing the hot-melt pillar 43 through the positioning hole 53, the positioning function before hot-melt connection can be realized, thereby limiting the relative positions between the supporting member 50 and the isolation structure 42, and ensuring a reliable hot-melt connection between the supporting member 50 and the isolation structure 42 while avoiding the displacement between the supporting member 50 and the isolation structure 42 during the hot-melt connection, which is beneficial to the accuracy of subsequent assembling.

In some embodiments, in the thickness direction of the plate-shaped supporting member, there is a gap T1 between the surface of one side of the second section 52 adjacent to the isolation structure 42 and the isolation structure 42. When the second section is fixedly connected to the isolation structure, the fixed connection structure may cause deformation of the supporting member. For example, when the second section 52 is heat-melt fixed to the isolation structure 42, the stress at a hot-melt part may cause deformation of the supporting member 50, and the supporting member 50 may affect the fixed connection between the supporting member 50 and the electrode assembly 30. Setting the gap T1 between the surface of one side of the second section 52 adjacent to the isolation structure 42 and the isolation structure 42 can reduce the stress in the hot-melt part, thereby reducing the deformation of the supporting member 50.

The thickness of the supporting member 50 affects the stiffness of the supporting member 50 itself. Setting the gap T1 according to the thickness of the supporting member 50 can control the reasonable deformation amount of the supporting member 50 during hot-melt fixation, and ensure the reliable connection between the supporting member 50 and the electrode assembly 30. If the height of the gap T1 is too high or too low, when the second section 52 is hot-melt fixed to the isolation structure 42, the hot-melt part may form a stress that pulls or squeezes the second section 52, so that the hot-melting effect becomes worse, resulting in a significant deformation of the first section 51 that is fixedly connected to the outer contour of the electrode assembly 30, which may affect the reliable connection between the supporting member 50 and the electrode assembly 30.

In FIG. 9, the supporting member 50 is a plate-shaped supporting member, and T1 may meet: 0.2*T2≤T1≤T2. For example, the value of T1 may be 0.4*T2, 0.65*T2, and 0.8*T2. T2 is the thickness of the plate-shaped supporting member. Here, by making the gap T1 meet the specific size relationship with the thickness of the supporting member 50, the hot-melt effect of the hot-melt connection between the second section 52 and the isolation structure 42 may be improved and the deformation of the first section 51 of the supporting member 50 may be reduced, which is conducive to achieving a reliable connection between the supporting member 50 and the electrode assembly 30.

As mentioned above, the thickness of the supporting member 50 affects the stiffness of the supporting member 50 itself, and therefore, the position of the hot-melt part relative to the isolation structure 42 is set according to the thickness of the supporting member 50, which can control the reasonable deformation amount of the supporting member 50 during hot-melt fixation, and ensure the reliable connection between the supporting member 50 and the electrode assembly 30. If the hot-melt part is too close to the end portion of the isolation structure 42, the hot-melt range may be limited and it may be difficult to achieve a reliable connection, which may affect the hot-melt effect. For the hot-melt part, if the hot-melt part is too far away from the end portion of the isolation structure 42, an isolation structure 42 with a thicker size is required, which affects the length of the electrode assembly 30, thereby affecting the capacity of the battery cell 10.

In FIG. 9, the supporting member 50 is a plate-shaped supporting member, and the minimum distance T3 from the hot-melt part of the second section 52 and the isolation structure 42 to an end portion of one side of the isolation structure 42 adjacent to the electrode assembly 30 in the length direction of the electrode assembly 30 may meet: 4*T2≤T3≤15*T2. For example, the value of T3 may be 6*T2, 9.5*T2, 12*T2, 13.5*T2, and the like. T2 is the thickness of the plate-shaped supporting member. Here, by making the minimum distance of the hot-melt part relative to the end portion of the isolation structure 42 meet the specific size relationship with the thickness of the supporting member 50, the hot-melt effect can be improved, thereby realizing a reliable connection between the supporting member 50 and the electrode assembly 30, and improving the capacity of the battery cell 10.

Referring to FIG. 4 to FIG. 5 and FIG. 8 to FIG. 9, in some embodiments, the hot-melt connection structure between the second section 52 and the isolation structure 42 includes a positioning hole 33 located on the second section 52 and a hot-melt pillar 43 located on the surface of the isolation structure 42. The hot-melt pillar 43 passes through the positioning hole 33 and is hot-melt connected to the positioning hole 33. In this embodiment, by allowing the hot-melt pillar 43 on the isolation structure 42 to pass through the positioning hole 33 on the second section 52, the hot-melt part can be effectively positioned, thereby facilitating performing a hot-melt operation on one side of the second section 52 away from the isolation structure 42 through a hot-melt device.

Referring to FIG. 3 to FIG. 5, the second sections 52 at both ends of the supporting member 50 may be each provided with at least one positioning hole 33, and side surfaces of the second insulating block 422 and the third insulating block 423 may be each provided with at least one hot-melt pillar 43. During specific mounting, the hot-melt pillars 43 on the second insulating block 422 and the third insulating block 423 may be inserted into the positioning holes 33 for positioning, and then the hot-melt pillars 43 are heated by the hot-melt device to melt. The melted material may be combined with the supporting member 50 to achieve a reliable fixed connection.

The electrode assembly 30 and the supporting member 50 may be fixedly connected in various manners. In some embodiments, the main body part 31 of the electrode assembly 30 and the supporting member 50 are fixed by bonding with an adhesive tape 54. The supporting member 50 and the main body part 31 of the electrode assembly 30 are fixed by bonding with the adhesive tape 54, so that the connection operation of the supporting member 50 and the main body part 31 is more convenient, and there is no need to provide other structures for connection on the supporting member 50 and the electrode assembly 30. When the main body part 31 and the supporting member 50 are bonded by the adhesive tape 54, a long whole section of adhesive tape may be used for bonding, or a plurality of adhesive tapes 34 may also be used for bonding.

Referring to FIG. 3 and FIG. 7, in some embodiments, the electrode assembly 30 and the supporting member 50 are fixed by bonding with a plurality of adhesive tapes 34, and the plurality of adhesive tapes 34 are arranged at intervals in the thickness direction z of the cover plate 41. Compared with the method of fixing the electrode assembly 30 and the supporting member 50 by bonding with a long whole section of adhesive tape 34, a plurality of adhesive tapes 34 arranged at intervals can meet the requirement of fixed connection while saving the amount of adhesive tape and saving costs.

When the plurality of adhesive tapes 34 arranged at intervals in the thickness direction z of the cover plate 41 are used to achieve the fixed connection between the electrode assembly 30 and the supporting member 50, an excessively wide adhesive tape 34 requires a larger amount of adhesive tape and increases the cost, while an excessively narrow adhesive tape 34 cannot achieve sufficient connection strength and thus affecting the reliability of the fixed connection.

In FIG. 7, the width T4 of each adhesive tape 34 may meet: 0.02*L≤T4≤0.2*L. For example, the value of T4 may be 0.03*L, 0.075*L, 0.12*L, 0.16*L, and the like. L is the length of the supporting member 50 in the length direction of the electrode assembly 30. Here, by making the width of the adhesive tape 34 meet the specific size relationship with the length of the supporting member 50, the amount of adhesive tape can be saved as much as possible and the costs can be reduced while ensuring the reliable fixed connection between the supporting member 50 and the electrode assembly 30.

In FIG. 7, the supporting member 50 has two end portions in the thickness direction z of the cover plate 41, and spacings between two adhesive tapes 34 respectively adjacent to the two end portions among the plurality of adhesive tapes 34 and the corresponding end portions are T5. The spacing T5 reflects the position of an outermost adhesive tape 34 among the plurality of adhesive tapes 34 on the supporting member 50. When the outermost adhesive tape 34 adheres and fixes the supporting member 50, lifting of the end portion of the supporting member 50 can be effectively controlled.

If the spacing T5 is too large, the effect of lifting of the end portion of the supporting member 50 will be affected. If the spacing T5 is too small, the fixed connection region (for example, the hot-melt connection region) between the supporting member 50 and the isolation structure 42 may be restricted.

In some embodiments, the spacing T5 meets: 0.04*L≤T5≤0.2*L. For example, the value of T5 may be 0.06*L, 0.085*L, 0.13*L, 0.175*L, and the like. L is the length of the supporting member 50 in the length direction of the electrode assembly 30. Here, by making the spacing T5 meet the specific size relationship with the length L of the supporting member 50, the influence on the hot-melt region can be reduced and the lifting of the end portion of the supporting member 50 can be alleviated.

In FIG. 7, in the thickness direction z of the cover plate 41, a plurality of adhesive tapes 34 are arranged at intervals being spacings T6, and the spacings T6 may be equal or unequal. The plurality of adhesive tapes arranged at intervals allow the fixed connection function of the adhesive tapes 34 be distributed evenly in the length direction of the electrode assembly 30, which effectively controls the deformation of different positions of the supporting member 50, thereby achieving a more reliable fixed connection relationship between the electrode assembly 30 and the supporting member 50.

An excessively large spacing T6 affects the connection strength between the electrode assembly 30 and the supporting member 50, while an excessively small spacing T6 may increase the amount of adhesive tape, increase costs, and also increase the process of pasting the adhesive tape 34. In some embodiments, the spacing T6 between adjacent adhesive tapes 34 in the plurality of adhesive tapes 34 meets: 0.1*L≤T6≤0.5*L. For example, the value of T6 may be 0.2*L, 0.36*L, 0.42*L, and the like. L is the length of the supporting member 50 in the thickness direction z of the cover plate 41. Here, by making the spacing of the adjacent adhesive tapes 34 meet the specific size relationship with the length of the supporting member 50, the amount of adhesive tape can be saved as much as possible, the costs can be reduced, and the process can be saved while ensuring the reliable fixed connection between the supporting member 50 and the electrode assembly 30.

When mounted in the case 20, the supporting member 50 may occupy a certain space, which accordingly reduces the amount of electrolyte solution that can be accommodated in the case 20. In order to reduce the influence of the volume of the supporting member 50 on the space within the case 20, referring to FIG. 3 to FIG. 7, in some embodiments, the supporting member 50 has a plurality of hollowed-out or thinned accommodation regions 56. Here, the hollowed-out accommodation region 56 may include a through hole that penetrates the supporting member 50 in the thickness direction of the supporting member 50, and the thinned accommodation region may include a blind hole with a closed bottom.

The total volume V1 of the plurality of hollowed-out or thinned accommodation regions 56 and the total volume V2 of the solid part of the supporting member 50 may meet: 5%≤V1:(V1+V2)≤30%, for example, the value of V1:(V1+V2) is 10%, 15%, 20%, 25%, and the like. By arranging the plurality of hollowed-out or thinned accommodation regions 56 on the supporting member 50, more accommodation space is provided for the electrolyte solution and the amount of electrolyte solution in the battery cell 10 is increased, thereby improving the cycle life of the battery cell 10. In addition, the stamping process of the hollowed-out accommodation region 56 is easy to implement, thereby reducing the difficulty of processing, and being conducive to the entry, exit, and flow of the electrolyte solution.

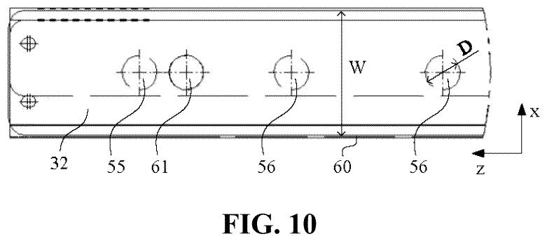

FIG. 10 is a schematic partial structural diagram of an insulating member wrapping a electrode assembly in some embodiments of the battery cell according to the present disclosure. The shape and size of the accommodation region 56 may be designed according to strength and stiffness requirements of the supporting member 50 itself, and a situation of being able to reduce the volume occupied by the supporting member 50. Referring to FIG. 4, FIG. 5, FIG. 7, and FIG. 10, in some embodiments, the plurality of hollowed-out or thinned accommodation regions 56 include: a plurality of circular holes.

The circular hole is capable of implementing the accommodation function for the electrolyte solution and gas, and is easy to process and form. If the diameter of the circular hole is too large, the strength and rigidity of the supporting member 50 will be weakened, thereby affecting the supporting effect of the supporting member 50 on the electrode assembly 30. If the diameter of the circular hole is too small, the space to accommodate the electrolyte solution will be limited.

Referring to FIG. 10, the diameter D of each circular hole meets:*W≤D≤(2/3)*W. For example, the value of D may be*W,*W,W, and the like. W is the width of the supporting member 50 in the thickness direction x of the electrode assembly 30. Here, by making the diameter of the circular hole meet a specific size relationship with the width of the supporting member 50, the amount of the electrolyte solution in the battery cell 10 can be increased and the cycle life of the battery cell 10 can be improved while meeting the reliable supporting effect of the supporting member 50 on the electrode assembly 30.

Referring to FIG. 3, in some embodiments, the plurality of hollowed-out or thinned accommodation regions 56 are arranged at equal intervals in the length direction of the electrode assembly 30. By arranging the accommodation regions 56 at equal intervals, the impact of the hollowed-out or thinned accommodation regions 56 on the stiffness and strength of the supporting member 50 may be more uniform, thereby avoiding local insufficient strength or local large deformation of the supporting member 50, and improving the supporting effect of the supporting member 50 on the electrode assembly 30.

In order to prevent the electrode assembly 30 from directly contacting the inner wall of the case 20, referring to FIG. 3 and FIG. 10, in some embodiments, the battery cell 10 further includes an insulating member 60 located within the case 20. The insulating member 60 wraps at least a part of the electrode assembly 30 and at least a part of the supporting member 50, and is capable of separating the cavity 21 of the case 20 from the electrode assembly 30. Regarding the insulating member 60, it may include an insulating thin layer (for example, a Mylar film) formed by wrapping a thin film of an insulating material on the electrode assembly 30. The insulating member 60 may wrap the electrode assembly 30 and the supporting member 50 together.

When assembling the insulating member 60 and the electrode assembly 30, a grabbing apparatus having a positioning mechanism is usually used to grab the insulating member 60, wherein the positioning mechanism is positioned through a first positioning hole on the insulating member 60. The supporting member 50 may also be provided with a second positioning hole for assembling and positioning.

In FIG. 3 and FIG. 10, a region of the insulating member 60 wrapping the supporting member 50 has a first positioning hole 61, and the supporting member 50 has a second positioning hole 55. The second positioning hole 55 may be located on one side of the plurality of hollowed-out or thinned accommodation regions 56 adjacent to the end portion of the supporting member 50, such that the second positioning hole 55 is located in a position adjacent to the end portion of the supporting member 50, thereby facilitating the positioning and operation of the supporting member 50 by the positioning device.

Referring to FIG. 10, the first positioning hole 61 does not overlap with the second positioning hole 55, and in this way, the electrode assembly 30 may be effectively prevented from lap-jointing with the case 20 through the second positioning hole 55 and the first positioning hole 61 to cause corrosion of the case 20. As may be seen from FIG. 10, the first positioning hole 61 is located on the right side of the second positioning hole 55, and it is difficult for the active material falling off from the electrode assembly 30 to reach the inner wall of the case 20 through the second positioning hole 55 and the first positioning hole 61.

Referring to FIG. 10, in some embodiments, the plurality of hollowed-out accommodation regions 56 on the supporting member 50 do not overlap with the first positioning hole 61. In this way, it can effectively prevent the electrode assembly 30 from lap-jointing with the case 20 through the hollowed-out accommodation region 56 and the first positioning hole 61 to cause corrosion of the case 20. As may be seen from FIG. 10, the first positioning hole 61 is located on the left side of the hollowed-out accommodation region 56, and it is difficult for the active material falling off from the electrode assembly 30 to reach the inner wall of the case 20 through the hollowed-out accommodation region 56 and the first positioning hole 61.

Based on the foregoing embodiments of the battery cell of the present disclosure, the present disclosure further provides embodiments of batteries employing the foregoing embodiments of the battery cell. The battery includes the battery cell of any of the aforementioned embodiments. The battery using the aforementioned embodiments of the battery cell can achieve better reliability in use.

In one aspect of the present disclosure, an electrical device is provided, including the aforementioned battery. The electrical device using the aforementioned battery can achieve better reliability in use.

Although the present disclosure has been described with reference to some embodiments, various improvements may be made thereto and components thereof may be replaced with equivalents without departing from the scope of the present disclosure. In particular, the technical features mentioned in the various embodiments may be combined in any manner as long as there is no structural conflict. The present disclosure is not limited to the particular embodiments disclosed herein, and includes all technical solutions falling within the scope of the claims.

What is claimed is:

1. A battery cell, comprising:
a case having an end portion opening;
an electrode assembly arranged in the case;
a cover plate arranged on the end portion opening;
an isolation structure arranged on one side of the cover plate adjacent to the electrode assembly; and
a supporting member fixedly connected to the isolation structure and configured to support the electrode assembly.

2. The battery cell according to claim 1, wherein the supporting member is a plate-shaped supporting member, and the supporting member comprises:
a first section, wherein the first section is arranged opposite to a main body part of the electrode assembly in a thickness direction of the supporting member; and
a second section, wherein the second section is located on at least one side of the first section in a thickness direction of the cover plate, and the second section protrudes from the main body part of the electrode assembly in the thickness direction of the cover plate,
wherein the second section is fixedly connected to the isolation structure.

3. The battery cell according to claim 2, wherein the second section is fixedly connected to the isolation structure by hot melting.

4. The battery cell according to claim 3, wherein the hot-melt connection structure between the second section and the isolation structure comprises a positioning hole and a hot-melt pillar, and the hot-melt pillar passes through the positioning hole and is hot-melt connected to the positioning hole.

5. The battery cell according to claim 2, wherein in the thickness direction of the plate-shaped supporting member, there is a gap T1 between the surface of one side of the second section adjacent to the isolation structure and the isolation structure.

6. The battery cell according to claim 5, wherein T1 meets:
0.2*T2≤T1≤T2;
wherein T2 is the thickness of the plate-shaped supporting member.

7. The battery cell according to claim 2, wherein in the thickness direction of the cover plate, the minimum distance T3 from a connection part of the second section and the isolation structure to an end portion of one side of the isolation structure adjacent to the main body part meets:
4*T2≤T3≤15*T2;
wherein T2 is the thickness of the plate-shaped supporting member.

8. The battery cell according to claim 1, wherein the main body part of the electrode assembly and the supporting member are fixed by bonding with an adhesive tape.

9. The battery cell according to claim 8, wherein the main body part of the electrode assembly and the supporting member are fixed by bonding with a plurality of adhesive tapes, and the plurality of adhesive tapes are arranged at intervals in the thickness direction of the cover plate.

10. The battery cell according to claim 9, wherein in the thickness direction of the cover plate, the width T4 of each adhesive tape meets:
0.02*L≤T4≤0.2*L;
wherein L is the length of the supporting member in the thickness direction of the cover plate.

11. The battery cell according to claim 9, wherein the supporting member has two end portions in the thickness direction of the cover plate, and spacings T5 between two adhesive tapes respectively adjacent to the two end portions among the plurality of adhesive tapes and the corresponding end portions meet:
0.04*L≤T5≤0.2*L;
wherein L is the length of the supporting member in the thickness direction of the cover plate.

12. The battery cell according to claim 9, wherein in the thickness direction of the cover plate, a spacing T6 between adjacent adhesive tapes among the plurality of adhesive tapes meets:
0.1*L≤T6≤0.5*L;
wherein L is the length of the supporting member in the thickness direction of the cover plate.

13. The battery cell according to claim 1, wherein the battery cell comprises two cover plate, two end portion openings are respectively provided at both ends of the case, and each of the cover plates is arranged on the corresponding end portion opening.

14. The battery cell according to claim 13, wherein the two cover plates comprise a first cover plate connected to the end portion opening on one side of the case; the isolation structure comprises: a first insulating block and a second insulating block, the first insulating block is fixed on a surface of one side of the first cover plate adjacent to the electrode assembly, and at least a part of the second insulating block is located between the first insulating block and the main body part of the electrode assembly, and is fixedly connected to the supporting member.

15. The battery cell according to claim 14, wherein the first insulating block is configured to limit the position of the second insulating block in at least one of the first direction and the second direction, and is in clearance fit with the second insulating block in at least one of the first direction and the second direction, and the first direction and the second direction are perpendicular to each other and both are perpendicular to the thickness direction of the cover plate.

16. The battery cell according to claim 13, wherein the two cover plates further comprise a second cover plate connected to the end portion opening on the other side of the case; the isolation structure is fixed on a surface of one side of the second cover plate adjacent to the electrode assembly, and is fixedly connected to the supporting member.

17. The battery cell according to claim 1, wherein the supporting member has a plurality of hollowed-out or thinned accommodation regions, and the plurality of hollowed-out or thinned accommodation regions comprise: a plurality of circular holes, wherein the diameter D of each circular hole meets:
$$( 1 / 3 ) * W \leq D \underline{<} ( 2 / 3 ) * W ;$$
wherein W is the width of the supporting member in the thickness direction of the main body part of the electrode assembly.

18. The battery cell according to claim 1, further comprising:
an insulating member located within the case and wrapping at least a part of the electrode assembly and at least a part of the supporting member, and configured to separate the case from the electrode assembly;
wherein a region of the insulating member wrapping the supporting member has a first positioning hole, the supporting member has a second positioning hole, wherein the first positioning hole does not overlap with the second positioning hole.

19. A battery, comprising the battery cell according to claim 1.

20. A electrical device, comprising the battery according to claim 19.
